(19) United States
(12) Patent Application Publication
(10) Pub. No.: US 2011/0267761 A1
(43) Pub. Date: Nov. 3, 2011

(54) DATA STORAGE ASSEMBLY

(75) Inventors: WEN-TANG PENG, Tu-Cheng (TW); MO-MING YU, Shenzhen City (CN); LEI ZHENG, Shenzhen City (CN)

(73) Assignees: HON HAI PRECISION INDUSTRY CO., LTD., TU-CHENG (TW); HONG FU JIN PRECISION INDUSTRY (ShenZhen) CO., LTD., ShenZhen City (CN)

(21) Appl. No.: 12/947,738

(22) Filed: Nov. 16, 2010

(30) Foreign Application Priority Data
Apr. 28, 2010 (CN) 201010158836.6

(51) Int. Cl. G06F 1/16

(52) U.S. Cl. 361/679.31

(57) ABSTRACT

A data storage assembly includes a disk tray. The disk tray includes a longitudinal tray body and two connectors. The longitudinal tray body has a first axis. The longitudinal tray body is configured to receive two data storage devices. The two connectors are located on opposite sides of the longitudinal tray body along a first axis. The two connectors are configured to connect the two data storage devices.

### BACKGROUND

1. Technical Field

The present disclosure relates to data storage, and especially to a data storage assembly used in a computer or a server.

2. Description of Related Art

Servers often run for long periods without interruption, requiring increased reliability and durability accordingly. For example, servers may incorporate faster and higher-capacity hard disks. More than one instance of hardware modules such as power supplies and hard disks is arranged in one server, so that if one fails another is automatically available. However, space in servers is usually limited to arrange hard disks. Each hard disk further needs one mounting device to be fixed to the server. It is a waste of space to place the two separate hard disks.

### BRIEF DESCRIPTION OF THE DRAWINGS

Many aspects of the embodiments can be better understood with references to the following drawings. The components in the drawings are not necessarily drawn to scale, the emphasis instead being located upon clearly illustrating the principles of the embodiments. Moreover, in the drawings, like reference numerals designate corresponding parts throughout the several views.

FIG. 1 is an exploded view of a data storage assembly according to one embodiment.

FIG. 2 is an assembled view with one data storage device assembled in a disk tray of FIG. 1.

FIG. 3 is an assembled view with one of two data storage devices assembled in a disk tray of FIG. 1.

FIG. 4 is an assembled view of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

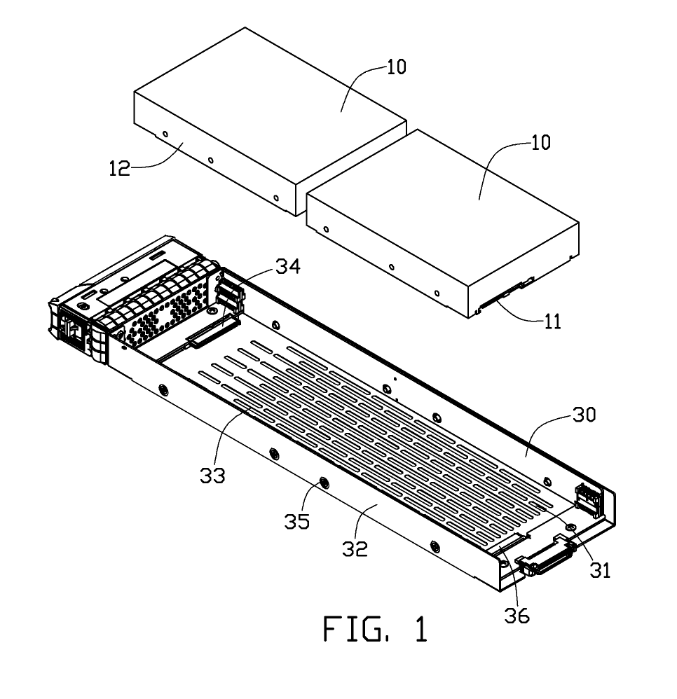

Referring to FIG. 1, a data storage assembly may provide at least one data storage device to a computer or a server. In one embodiment, the data storage assembly includes a disk tray 30 and two data storage devices 10. The two data storage devices 10 may be mounted to the disk tray 30 along a longitudinal axis.

The disk tray 30 includes a longitudinal tray body 31 and two connectors 34, 36. The longitudinal tray body 31 includes a bottom plate 33 and a two side plates 32 extending from the bottom plate 33. The two side plates 32 are substantially perpendicular to the bottom plate 33 and substantially parallel to each other. A receiving space is defined by the longitudinal tray body 31 enclosed by the bottom plate 33 and the two side plates 32. A plurality of heat dissipation slots is defined in the bottom plate 33. The two connectors 34, 36 are located on opposite sides of the bottom plate 33.

The two connectors 34, 36 are situated on opposite sides of the first axis. The first axis is substantially parallel to the bottom plate 33 and the two side plates 32. The two connectors 34, 36 are located on the same plane parallel to the bottom plate 33.

In one embodiment, the two data storage devices 10 may have the same structure. Each data storage device 10 includes two sidewalls 12. Each data storage device 10 is capable of being fastened to the two sidewalls 12 through the two side plates 32 by a plurality of fasteners 35. A slot 11 is defined in a rear wall of each data storage device 10 to couple to one of the two connectors 34, 36. A height of each data storage device 10 is substantially equal to a height of the two side plates 32. A distance between the two side plates 32 is substantially equal to a width of each data storage device 10. Thus, the longitudinal tray body 31 may precisely receive the two data storage devices 10.

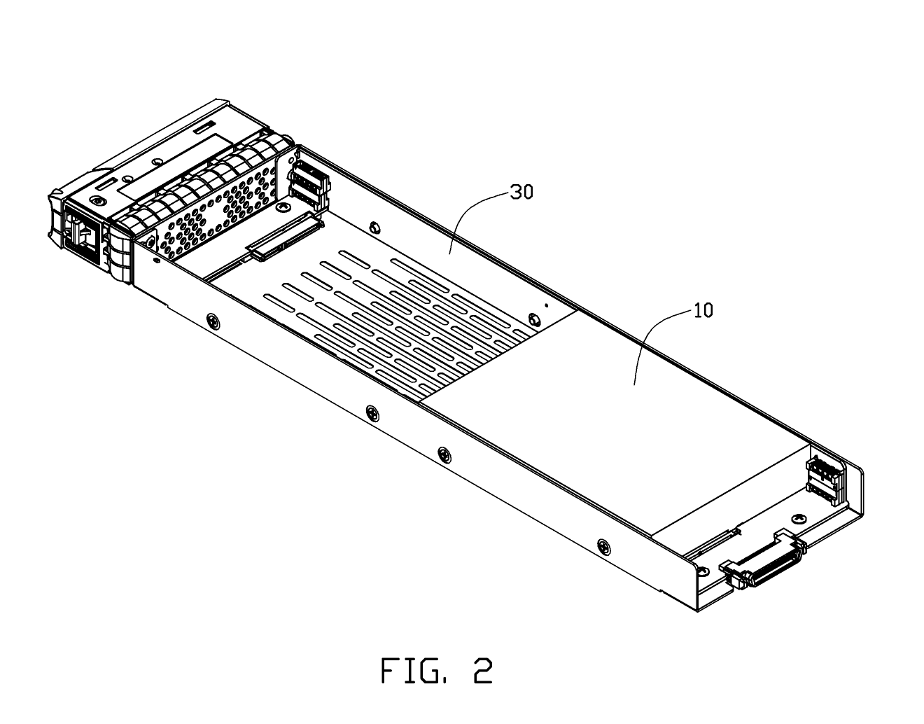

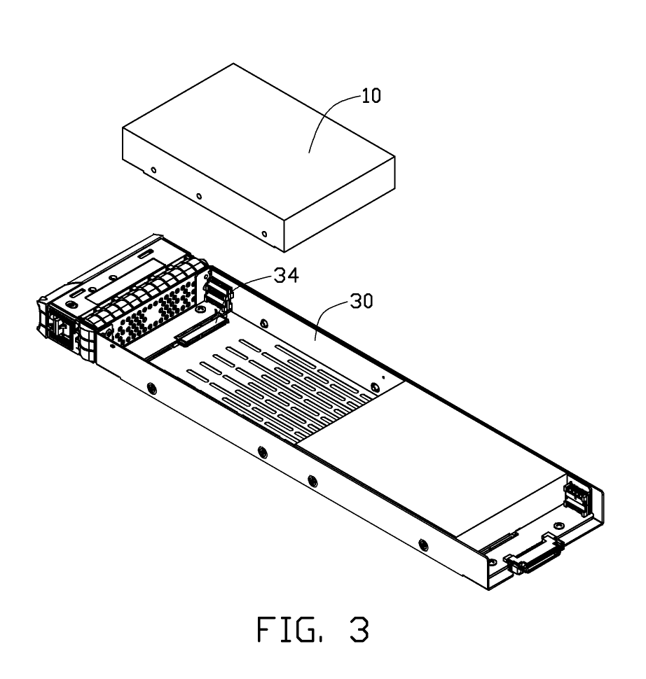

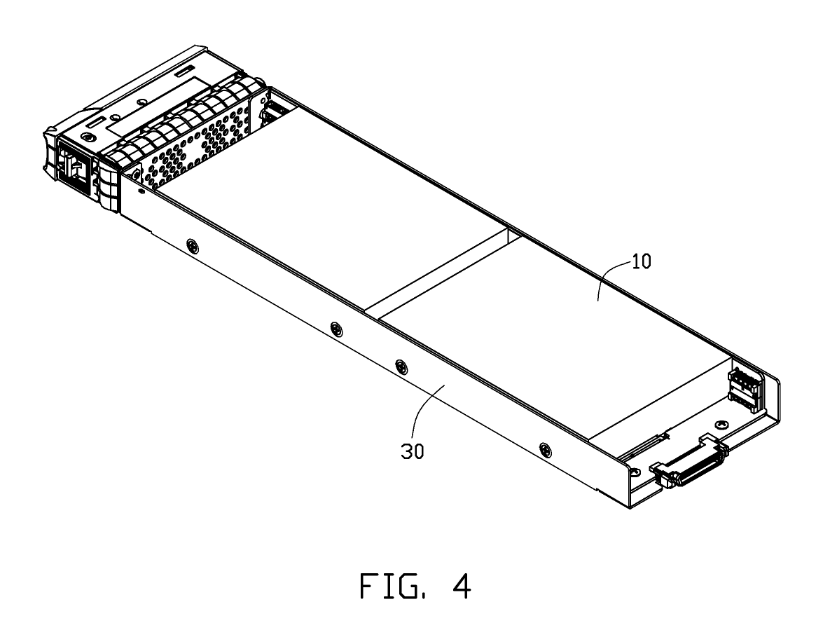

Referring to FIG. 2 through FIG. 4, during assembly of the two data storage devices 10 to the disk tray 30, the two data storage devices 10 are located in the receiving space of the longitudinal tray body 31. The two data storage devices 10 move along opposite axes to be received in the two connectors 34, 36. The two data storage devices 10 are mounted to the disk tray 30 through the fasteners 35. A gap between the two data storage devices 10 is left to provide disassembly space. A width of the gap may equal or exceed a depth of each of the two slots 11 of the two data storage devices 10. A distance between the two connectors 34, 36 along the first axis may equal or larger than twice lengths of each of two data storage device 10.

When the width of the gap equals or exceeds the depth of each of the two slots 34, 36 and is less than twice the depth of each of the two slots 34, 36, only one data storage device 10 can be mounted to the disk tray 30 or removed from the disk tray 30 at a time.

Thus, the longitudinal tray body 31 may receive the two data storage devices 10. When the two data storage devices 10 are used in the computer or the server, the disk tray 30 may occupy minimal space for mounting the two data storage devices 10.

In other embodiments, the disk tray 30 may receive two data storage devices of different size. A gap should be also defined between the two data storage devices for facilitating assembly and disassembly.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A data storage assembly comprising:
a disk tray, comprising
a longitudinal tray body, having a first axis, the longitudinal tray body configured to receive two data storage devices; and
two connectors located on opposite sides of the longitudinal tray body and opposite sides of the first axis, the two connectors configured to electronically connect with the two data storage devices therebetween.

2. The data storage assembly of claim 1, wherein the longitudinal tray body comprises a bottom plate and two side plates, the two side plates are substantially perpendicular to the bottom plate, the two side plates are substantially parallel to the first axis, and the two data storage devices are sandwiched between the two side plates.

3. The data storage assembly of claim 2, wherein a distance between the two side plates is substantially equal to a width of each of the two data storage devices.

4. The data storage assembly of claim 2, wherein the two connectors are located on the same plane that is parallel to the bottom plate.

5. The data storage assembly of claim 2, wherein a height of each of the two side plates is substantially equal to a height of each of the two data storage devices.

6. The data storage assembly of claim 2, wherein the two side plates are configured to fasten the two data storage devices.

7. The data storage assembly of claim 1, wherein a distance between the two connectors along the first axis equals to twice length one of one of the two data storage devices.

8. A data storage assembly comprising:
a disk tray, comprising
a longitudinal tray body, having a first axis, the tray body configured to receive two data storage devices, and
two connectors located on opposite sides of the longitudinal tray body along a first axis, the two connectors configured to receive the two data storage devices along two opposite directions along the first axis.

9. The data storage assembly of claim 8, wherein the longitudinal tray body comprises a bottom plate and two side plates, the two side plates are substantially perpendicular to the bottom plate, the two side plates are substantially parallel to the first axis, and the two data storage devices are sandwiched between the two side plates.

10. The data storage assembly of claim 9, wherein a distance between the two side plates is substantially equal to a width of each of the two data storage devices.

11. The data storage assembly of claim 9, wherein the two connectors are located on the same plane that is parallel to the bottom plate.

12. The data storage assembly of claim 9, wherein a height of each of the two side plates is substantially equal to a height of each of the two data storage devices.

13. The data storage assembly of claim 9, wherein the two side plates are configured to fasten the two data storage devices.

14. The data storage assembly of claim 8, wherein a distance between the two connectors along the first axis equals to twice length one of the two data storage devices.
